(19) United States
(12) Patent Application Publication
(10) Pub. No.: US 2019/0180472 A1
(43) Pub. Date: Jun. 13, 2019

(54) METHOD AND APPARATUS FOR DETERMINING PRECISE POSITIONING

(71) Applicant: Electronics and Telecommunications Research Institute, Daejeon (KR)

(72) Inventors: Gi Mun UM, Seoul (KR); Chang Eun LEE, Daejeon (KR); Sang Joon PARK, Sejong-si (KR); Kwang Yong KIM, Sejong-si (KR); Sun Joong KIM, Sejong-si (KR); So Yeon LEE, Sejong-si (KR); Kee Seong CHO, Daejeon (KR); Eun Young CHO, Daejeon (KR)

(73) Assignee: Electronics and Telecommunications Research Institute, Daejeon (KR)

(21) Appl. No.: 16/213,829

(22) Filed: Dec. 7, 2018

(30) Foreign Application Priority Data
Dec. 8, 2017 (KR) 10-2017-0168706
Nov. 28, 2018 (KR) 10-2018-0149173

(51) Int. Cl. G06T 7/73; G01S 5/02

(52) U.S. Cl. CPC G06T 7/74; G01S 5/0257

(57) ABSTRACT

The present disclosure discloses a method of determining precise positioning. A method of determining precise positioning according to an embodiment of the present disclosure includes: determining at least one piece of image positioning information of at least one image object detected from at least one image; determining at least one piece of wireless positioning information of at least one wireless object on the basis of signal strength of a wireless signal; performing mapping for the at least one piece of image positioning information and the at least one piece of wireless positioning information; and determining final positioning information on the basis of the at least one piece of image positioning information, and the at least one piece of wireless positioning information for which mapping is performed.

### CROSS REFERENCE TO RELATED APPLICATION

The present application claims priority to Korean Patent Application No. 10-2017-0168706 and 10-2018-0149173, filed Dec. 8, 2017 and Nov. 28, 2018, the entire contents of which is incorporated herein for all purposes by this reference.

### BACKGROUND OF THE INVENTION

### Field of the Invention

The present disclosure relates generally to a method and apparatus for determining a position of an object. More particularly, the present disclosure relates to a method and apparatus for determining positioning information of an object by analyzing images obtained by using a multi-camera system.

### Description of the Related Art

Sports images are being broadcast through media, and the media consumption environment of viewers according to the same is changing rapidly. In response to changes in media consumption environment, a technique for identifying a player has been conducted according to the development of supplementary services for sports players.

However, since the movements of players participating in a sport game are fast and various, and it is not easy to detect a player object present in an image by analyzing the image.

Particularly, for sports such as football or ice hockey, a player object is not detected since the player object moves fast. In addition, confusion between detected objects frequently occurs since the player objects frequently collide.

### SUMMARY OF THE INVENTION

An objective of the present disclosure is to provide a method of apparatus of accurately detecting a position of an object included in an image.

Another objective of the present disclosure is to provide a method of apparatus of accurately detecting an object without missing the same spatially and temporally by combining object positioning information based on a wireless signal transmitted from a device attached on a player and object positioning information detected on the basis of image analysis.

Technical problems obtainable from the present disclosure are not limited by the above-mentioned technical problems, and other unmentioned technical problems may be clearly understood from the following description by those having ordinary skill in the technical field to which the present disclosure pertains.

According to an aspect of the present disclosure, there is provided a method of determining precise positioning, wherein the method includes: determining at least one piece of image positioning information of at least one image object detected from at least one image; determining at least one piece of wireless positioning information of at least one wireless object on the basis of signal strength of a wireless signal; performing mapping for the at least one piece of image positioning information and the at least one piece of wireless positioning information; and determining final positioning information on the basis of information of the at least one piece of image positioning information and the at least one piece of wireless positioning information for which mapping is performed.

According to another aspect of the present disclosure, there is provided an apparatus for determining precise positioning, wherein the apparatus includes: an image positioning information determining unit determining at least one piece of image positioning information of at least one image object detected from at least one image; a wireless positioning information determining unit determining at least one piece of wireless positioning information on the basis of signal strength of a wireless signal; a positioning information mapping unit performing mapping for the at least one piece of image positioning information and the at least one piece of wireless positioning information; and a final positioning information determining unit determining final positioning information on the basis of information of the at least one piece of image positioning information and the at least one piece of wireless positioning information for which mapping is performed.

It is to be understood that the foregoing summarized features are exemplary aspects of the following detailed description of the present disclosure without limiting the scope of the present disclosure.

According to the present disclosure, there is provided a method of apparatus of accurately detecting a position of an object included in an image.

In addition, according to the present disclosure, there is provided a method of apparatus of accurately detecting an object without missing the same spatially and temporally by combining object positioning information based on a wireless signal transmitted from a device attached on a player and object positioning information detected on the basis of image analysis.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a block diagram showing a configuration of a precise positioning determining apparatus according to an embodiment of the present disclosure;

FIG. 2A is a view showing an example of arranging cameras used in the precise positioning determining apparatus according to an embodiment of the present disclosure;

FIG. 2B is a view showing operation of an image positioning information determining unit provided in the precise positioning determining apparatus according to an embodiment of the present disclosure;

FIG. 3A is a view showing an example of arranging access points used in the precise positioning determining apparatus according to an embodiment of the present disclosure;

FIG. 3B is a view showing operation of a wireless positioning information determining unit provided in the precise positioning determining apparatus according to an embodiment of the present disclosure;

FIG. 4 is a block diagram showing a detail configuration of an positioning information mapping unit provided in the precise positioning determining apparatus according to an embodiment of the present disclosure;

FIG. 5 is a view of a flowchart showing a precise positioning determining method according to an embodiment of the present disclosure; and

FIG. 6 is a block diagram showing an example of a computing system executing a precise positioning determining method and apparatus according to an embodiment of the present disclosure.

### DETAILED DESCRIPTION OF THE INVENTION

Hereinbelow, exemplary embodiments of the present disclosure will be described in detail with reference to the accompanying drawings such that the present disclosure can be easily embodied by one of ordinary skill in the art to which this invention belongs. However, the present disclosure may be variously embodied, without being limited to the exemplary embodiments.

In the description of the present disclosure, the detailed descriptions of known constitutions or functions thereof may be omitted if they make the gist of the present disclosure unclear. Also, portions that are not related to the present disclosure are omitted in the drawings, and like reference numerals designate like elements.

In the present disclosure, when an element is referred to as being “coupled to”, “combined with”, or “connected to” another element, it may be connected directly to, combined directly with, or coupled directly to another element or be connected to, combined directly with, or coupled to another element, having the other element intervening therebetween. Also, it should be understood that when a component “includes” or “has” an element, unless there is another opposite description thereto, the component does not exclude another element but may further include the other element.

In the present disclosure, the terms “first”, “second”, etc. are only used to distinguish one element, from another element. Unless specifically stated otherwise, the terms “first”, “second”, etc. do not denote an order or importance. Therefore, a first element of an embodiment could be termed a second element of another embodiment without departing from the scope of the present disclosure. Similarly, a second element of an embodiment could also be termed a first element of another embodiment.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components described in the various embodiments and additional other components are included in the scope of the present disclosure.

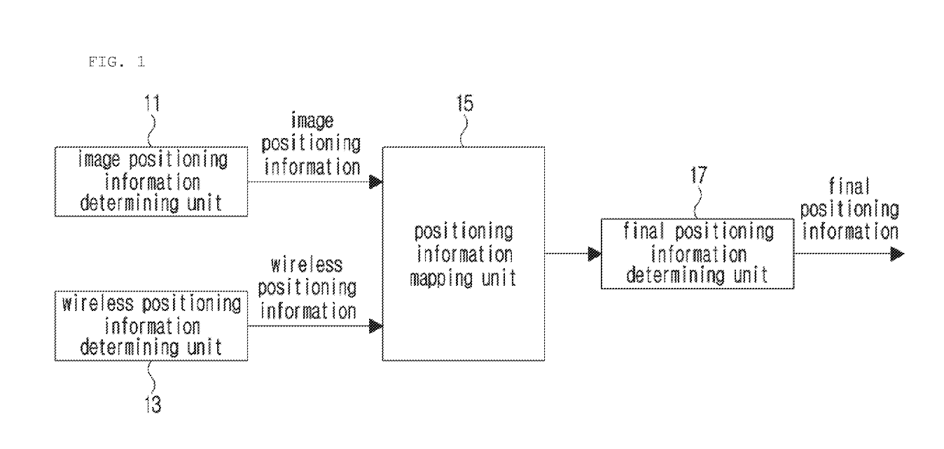

FIG. 1 is a block diagram showing a configuration of a precise positioning determining apparatus according to an embodiment of the present disclosure.

Referring to FIG. 1, a precise positioning determining apparatus according to an embodiment of the present disclosure may include an image positioning information determining unit 11, a wireless positioning information determining unit 13, a positioning information mapping unit 15, and a final positioning information determining unit 17.

The image positioning information determining unit 11 may obtain an image provided from a plurality of camera devices provided for a plurality of objects different from each other, analyze the obtained plurality of images, and detect image positioning information representing an object position included in the image.

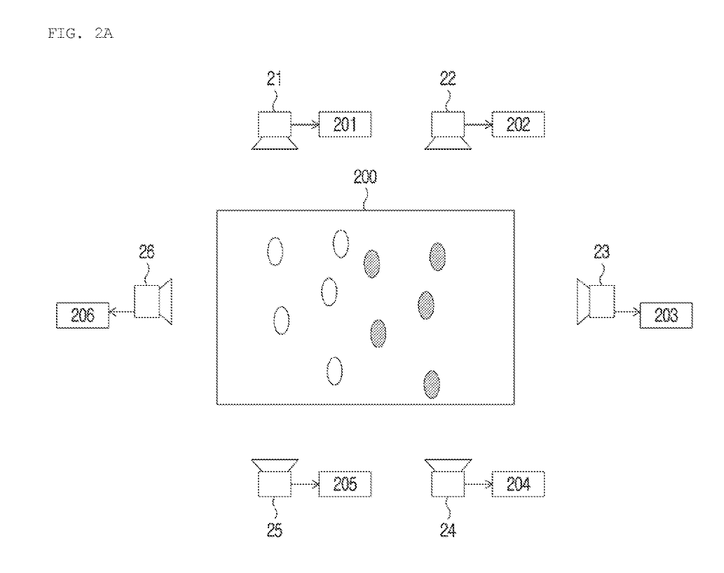

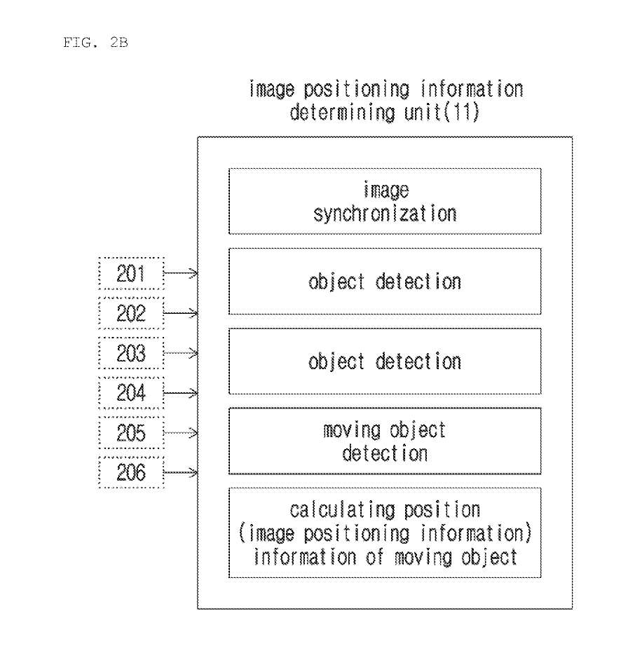

For example, a plurality of cameras 21, 22, 23, 24, 25, and 26 (refer to FIG. 2A) may be provided to capture a capture area 200 by being fixed to a different position. In response to the same, the image positioning information determining unit 11 may confirm information of positions where the plurality of cameras 21, 22, 23, 24, 25, and 26 are fixed, and angles that the plurality of cameras 21, 22, 23, 24, 25, and 26 capture the capture area 200.

The image positioning information determining unit 11 may be connected to the plurality of cameras 21, 22, 23, 24, 25, and 26 by using wired/wireless communication, and receive images 201, 202, 203, 204, 205, and 206 respectively captured by the plurality of cameras 21, 22, 23, 24, 25, and 26. In the images 201, 202, 203, 204, 205, and 206, information of a time at which the image is captured (hereinafter, “temporal information”) may be included. The image positioning information determining unit 11 may check temporal information and synchronize the images 201, 202, 203, 204, 205, and 206.

In addition, the image positioning information determining unit 11 may detect at least one moving object from each of the plurality of synchronized images. For example, the image positioning information determining unit 11 may detect at least one moving object taking into account a preset image pattern (for example, size, color, form, etc.).

Subsequently, the image positioning information determining unit 11 may perform mapping for each of at least one moving object detected from each of the plurality of images, and calculate position information, that is, image positioning information, of the moving object that is mapped by taking into account an installation position, a capture angle of the camera.

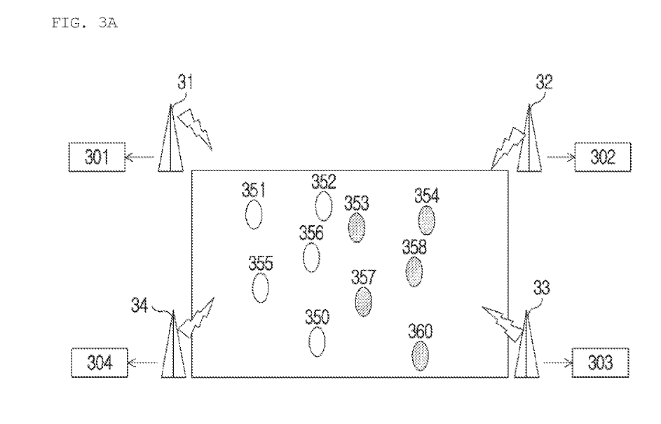

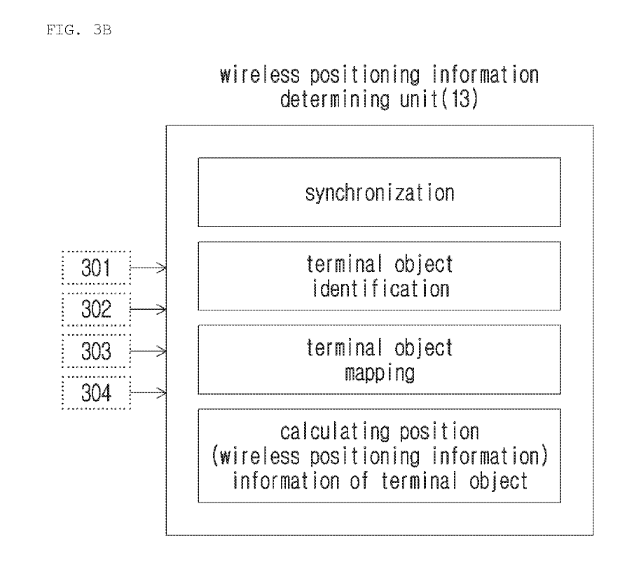

Meanwhile, the capture area 200 may be a stadium area where a sporting game is going on, and at least one moving object may be an object corresponding to a player who participates the sport game in a stadium. In addition, wireless terminals 351, 352, 353, 354, 355, 356, 357, 358, 359, and 360, (refer to FIG. 3A) may be attached on respective players for determining respective positions. Such wireless terminals may be respectively managed as terminal objects 351, 352, 353, 354, 355, 356, 357, 358, 359, and 360. In addition, a plurality of access points 31, 32, 33, and 34 may be installed nearby the capture area 200, and the access points 31, 32, 33, and 34 may perform wireless communication with a terminal object on the basis of a preset communication method. In addition, the access points 31, 32, 33, and 34 may be connected to the wireless positioning information determining unit 13 by using a wired/wireless communication, and provide to the wireless positioning information determining unit 13 information 301, 302, 303, and 304 that is obtained from the terminal objects 351, 352, 353, 354, 355, 356, 357, 358, 359, and 360 by performing wireless communication with the same.

In an embodiment of the present disclosure, “access point” refers to a fixed station used for communication with terminal objects, may refer to a node, eNodeB, HeNB or other terms. The access point may include various targets having a function for communication with terminal objects regardless of terms used in the market such as a random access point, a relay access point, a router access point, etc.

In an embodiment of the present disclosure, a “terminal object” indicates a target referred to technical terms such as a mobile station (MS), a mobile terminal (MT), a subscriber station), a portable/mobile subscriber station, a user equipment (UE), an access terminal (AT), etc., and may include user-type electronic communication devices that include the entire or partial function of a mobile communication terminal, a mobile station, a mobile terminal, a subscriber station, a mobile subscriber station, a user apparatus, an access terminal, or etc.

On the basis of the above description, the wireless positioning information determining unit 13 may determine wireless positioning information representing a position of a terminal object by using information provided from an access point. For example, the wireless positioning information determining unit 13 may estimate wireless positioning information on the basis of received signal strength (RSS) of a signal received in a reference point, a time of arrival (TOA) of the signal, a time difference of arrival (TDOA) of the signal, a carrier signal phase of arrival (POA) of a carrier signal, an angle of arrival (AOA) of a signal. Particularly, the wireless positioning information determining unit 13 may estimate wireless positioning information on the basis of a method of measuring a distance by using attenuation of wireless signal, a method of determining positioning on the basis of triangulation, and a fingerprinting method using a radio map established in advance. Further, wireless positioning information may be estimated by using ultra-wideband (UWD) possibly transmitting a large amount of data in low power within a short distance.

As described above, the image positioning information determining unit 11 may calculate image positioning information of a moving object on the basis of an image, and the wireless positioning information determining unit 13 may estimate wireless positioning information of a terminal object. Herein, an object that becomes a target of each of the image positioning information and the wireless positioning information appears different. Accordingly, an object that becomes a target of each of the image positioning information and the wireless positioning information has to be mapped. On the basis of the same, the positioning information mapping unit 15 may process operation of mapping objects that respectively become targets of the image positioning information and the wireless positioning information.

For example, when image positioning information includes coordinate values (X_video, Y_video) of a position of a moving object, and wireless positioning information includes coordinate values (X_sensor, Y_sensor) represent a position of a terminal object, the positioning information mapping unit 15 determines a distance between the coordinate values (X_video, Y_video) of the image positioning information and the coordinate values (X_sensor, Y_sensor) of the wireless positioning information, and performs mapping for the image positioning information and the wireless positioning information on the basis of the determined distance.

In addition, when a moving object and a terminal object are respectively based on an image and a wireless signal, timing at which objects are detected may differ. Accordingly, the positioning information mapping unit 15 may synchronize timings at which objects are detected before performing mapping for the image positioning information and the wireless positioning information.

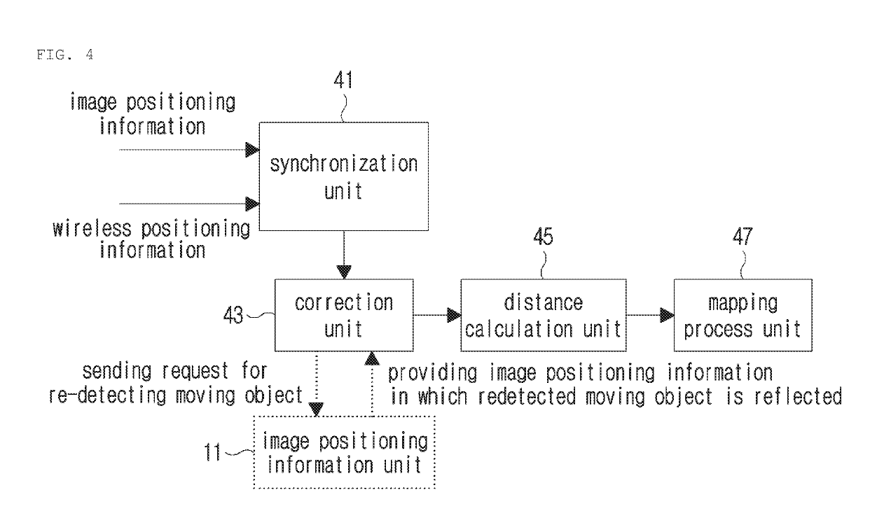

Further, detailed configuration and operation of the positioning information mapping unit 15 will be described with FIG. 4 attached below.

The final positioning information determining unit 17 may determine an object that is finally detected on the basis of the mapped image positioning information and the wireless positioning information, and provide final positioning information of the detected object, for example, coordinate values (X_fusion, Y_fusion) of final positioning information.

Additionally, coordinate values (X_fusion, Y_fusion) of final positioning information determined by using the final positioning information determining unit 17 may be provided to an image analysis unit 20 performing image analysis.

The image analysis unit 20 may analyze moving pattern information of an object included in an image. For example, the image analysis unit 20 may analyze moving pattern information of a player object included in a sport image. Herein, moving pattern information may include a movement distance of at least one player object, a speed of at least one player object, a movement path of at least one player object, position based statistic of at least one player object, etc.

FIG. 4 is a block diagram showing a detailed configuration of the positioning information mapping unit provided in the precise positioning determining apparatus according to an embodiment of the present disclosure.

Referring to FIG. 4, a positioning information mapping unit 40 may include a synchronization unit 41, a correction unit 43, a distance calculation unit 45, and a mapping process unit 47.

For example, a camera device may detect an image in a unit of 30 fps, and the image positioning information determining unit 11 may detect a moving object by analyzing a plurality of images captured as above, and determine image positioning information of detected moving objects. Meanwhile, an access point may check a wireless signal transmitted from a terminal object every 10 ms, and determine wireless positioning information of a terminal object by using the received wireless signal. As described above, since timings detecting image positioning information and wireless positioning information differ, the synchronization unit 41 may synchronize timings at which the image positioning information and the wireless positioning information are detected.

For example, timing at which wireless positioning information is detected is relatively later than timing at which image positioning information is detected, and thus the synchronization unit 41 may synchronize the timing at which the image positioning information is detected on the basis of the timing at which the wireless positioning information is detected.

A plurality of moving objects and a plurality of terminal objects may be present, and thus it is impossible to determine which objects correspond to each other. Accordingly, determining how the plurality of moving objects and the plurality of the terminal objects correspond to each other has to be performed. For the same, the distance calculation unit 45 may determine distance information of each object by using coordinate values (X_video, Y_video) of a moving object and coordinate values (X_sensor, Y_sensor) of a terminal object. For example, the distance calculation unit 45 may determine distance information Distance(X_video, Y_video, i) between a moving object and a terminal object by using Formula 1 below.

$$Distance ( X\_video , Y\_video , i ) = \sqrt{{( {X}_{video} ( i ) - {X}_{sensor} ( j ) )}^{2} + {( {Y}_{video} ( i ) - {Y}_{sensor} ( j ) )}^{2}} \qquad [ Formula 1 ]$$

Herein, i=1, 2, . . . M, M may be a number of moving objects, j=1, 2, . . . N, and N is a number of terminal objects.

It is preferable to detect the same number of moving objects and terminal objects, but the number of moving objects and terminal objects may be calculated differently. Taking into account the above, the correction unit 43 may check numbers of respective moving objects and terminal objects.

When a number of moving objects is determined to be relatively smaller than a number of terminal objects, it may mean that a moving object is not detected from an image. Accordingly, the correction unit 43 may send a request to the image positioning information determining unit 11 to re-detect a moving object. In response to the same, the image positioning information determining unit 11 may re-detect a moving object from a corresponding image, and determine and provide image positioning information of the re-detected moving object.

In another example, the image positioning information determining unit 11 may re-detect a moving object from an image at a previous time (t−1) or an image at a following time (t+1) on the basis of an image at a time (t) used for detecting a moving object.

Meanwhile, when a number of moving objects is determined to be equal or relatively greater than a number of terminal objects, it may means that a terminal object is not detected. When a terminal object is not detected on the basis of a wireless signal, re-detecting a terminal object at the corresponding time is not possible. Accordingly, the correction unit 43 may estimate coordinate values (X_sensor(j), Y_sensor(j)) of a terminal object that is lost by performing interpolation using coordinate values (X_sensor(j−1), Y_sensor(j−1)) of a terminal object determined at a previous time and coordinate values (X_sensor(j+1), Y_sensor(j+1)) of the terminal object determined at a following time.

The mapping process unit 47 may perform mapping for image positioning information and wireless positioning information by using distance information calculated by using the distance calculation unit 45. For example, a difference value with coordinate values(X_sensor, Y_sensor) of a terminal object may be determined on the basis of coordinate values(X_video(i), Y_video(i)) of an i-th moving object by using the distance calculation unit 45, and the mapping process unit 47 may determine a terminal object having the smallest difference coordinate values. On the basis of the same, mapping for the image positioning information and the wireless positioning information may be performed.

Further, a plurality of images is continuously obtained in every preset time unit, and thus correlation of a moving object included in the plurality of images may be determined. For example, it may be assumed that a first object include in a first image at a first time and a second object included in a second image at a second time are identical moving objects. The first object and the second object may be present in an approximated position, and may have a similar image characteristic, for example, a color, a color distribution, a color ratio, etc. Accordingly, the mapping process unit 47 may perform moving object mapping by analyzing a position of a moving object included in a spatially adjacent image, and perform mapping of image positioning information on the basis of the same.

Further, the mapping process unit 47 may preferentially complete mapping for image positioning information and wireless positioning information, perform mapping for image positioning information of a plurality of images obtained at times different from each other, and thus spatially precisely determine positioning information of an object by using the image positioning information and the wireless positioning information. In addition, positioning information of an object may be determined in detail by using image positioning information of a plurality of images without missing the object temporally.

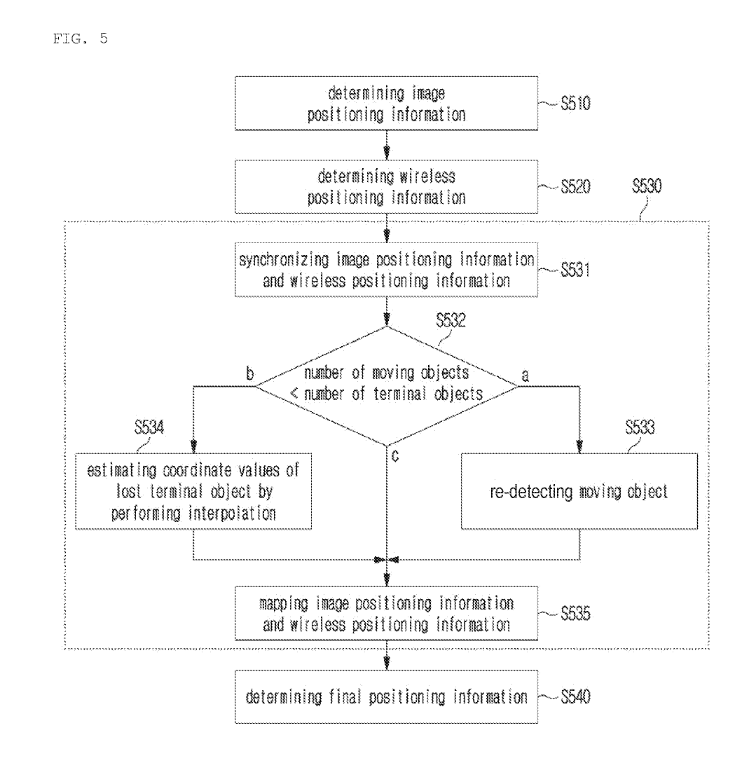

FIG. 5 is a view of a flowchart showing a precise positioning determining method according to an embodiment of the present disclosure.

A precise positioning determining method according to an embodiment of the present disclosure may be performed by a precise positioning determining apparatus method according to an embodiment of the present disclosure.

First, in S510, the precise positioning determining apparatus may obtain images that are provided from camera devices provided in a plurality of different objects, analyze the plurality of obtained images, and detect image positioning information representing a position of an object included in the image.

A plurality of cameras 21, 22, 23, 24, 25, and 26 (refer to FIG. 2) may be provided to capture a capture area 200 by being fixed to different objects. In response to the same, the precise positioning determining apparatus may determine positions at which the plurality of cameras 21, 22, 23, 24, 25, and 26 are fixed and angle information of that the plurality of cameras 21, 22, 23, 24, 25, and 26 capture the capture area 200.

The precise positioning determining apparatus may receive images 201, 202, 203, 204, 205, and 206 which are respectively captured from the plurality of cameras 21, 22, 23, 24, 25, and 26, determine information of capture times include in the images 201, 202, 203, 204, 205, and (hereinafter, referred as “temporal information”), and synchronize the plurality of images 201, 202, 203, 204, 205, and 206.

In addition, the precise positioning determining apparatus may detect at least one moving object by taking into account of a preset image pattern (for example, size, color, form, etc.), and perform mapping for at least one moving object detected from each of the plurality of images. In addition, the precise positioning determining apparatus may calculate position information, that is, image positioning information, of a moving object for which mapping is performed by taking into account an installation position of a camera device, a capture angle, etc.

Meanwhile, the capture area 200 may be a stadium area where a sport games is taking place, and at least one moving object may be an object corresponding to a player who participates the sport game in a stadium. In addition, a wireless terminal may be attached on a player so as to determine position of the player. Such a wireless terminal may be managed as a terminal object. In addition, a plurality of access points may be installed nearby the capture area 200, and the plurality of access points may perform wireless communication with a terminal object on the basis of a preset communication method. In addition, the plurality of access points may be connected to the precise positioning determining apparatus in wired/wireless communication, and provide to the precise positioning determining apparatus information obtained by performing wireless communication with the terminal object.

On the basis of the description above, in S520, the precise positioning determining apparatus may determine wireless positioning information representing an object of a terminal object by using information provided from the plurality of access points.

For example, the precise positioning determining apparatus may estimate wireless positioning information on the basis of received signal strength (RSS) of a signal received in a reference point, a time of arrival (TOA) of the signal, a time difference of arrival (TDOA) of the signal, a carrier signal phase of arrival (POA) of a carrier signal, an angle of arrival (AOA) of a signal. Particularly, the precise positioning determining apparatus may estimate wireless positioning information on the basis of a method of measuring a distance by using attenuation of wireless signal, a method of determining positioning on the basis of triangulation, and a fingerprinting method using a radio map established in advance. Further, wireless positioning information may be estimated by using ultra-wideband (UWD) possibly transmitting a large amount of data in low power within a short distance.

An object that becomes a target of each of image positioning information and wireless positioning information appears differently. Accordingly, an object that becomes a target of each of the image positioning information and the wireless positioning information has to be mapped. On the basis of the same, in S530, the precise positioning determining apparatus may process operation of mapping objects that respectively become targets of the image positioning information and the wireless positioning information.

For example, when image positioning information includes coordinate values (X_video, Y_video) representing a position of a moving object, and wireless positioning information includes coordinate values (X_sensor, Y_sensor) representing a position of a terminal object, the positioning information mapping unit 15 may determine a distance between the coordinate values (X_video, Y_video) of the image positioning information and the coordinate values (X_sensor, Y_sensor) of the wireless positioning information, and perform mapping for the image positioning information and the wireless positioning information on the basis of the determined distance.

In detail, a camera device may detect an image in a unit of 30 fps, and the precise positioning determining apparatus may detect a moving object by analyzing a plurality of images detected as above, and determine image positioning information of detected moving objects. Meanwhile, an access point may check a wireless signal transmitted from a terminal object every 10 ms, and determine wireless positioning information of a terminal object by using the received wireless signal. As described above, since timings of detecting image positioning information and wireless positioning information differ, S531, the precise positioning determining apparatus may synchronize timings at which the image positioning information and the wireless positioning information are detected.

For example, timing at which wireless positioning information is detected is relatively later than timing at which image positioning information is detected, and thus the precise positioning determining apparatus may synchronize the timing at which the image positioning information is detected on the basis of the timing at which the wireless positioning information is detected.

It is preferable to detect the same number of moving objects and terminal objects, but the number of moving objects and terminal objects may be calculated differently. Taking account the above, in S532, the precise positioning determining apparatus may check numbers of respective moving objects and terminal objects.

When a number of moving objects is determined to be relatively smaller than a number of terminal objects in S532-a, it may mean that a moving object is not detected from an image. Accordingly, in S533, the precise positioning determining apparatus may re-detect the moving object

For example, precise positioning determining apparatus may re-detect a moving object from a corresponding image, and determine and provide image positioning information of the re-detected moving object.

In another example, the precise positioning determining apparatus may re-detect a moving object from an image at a previous time (t−1) or an image at a following time (t+1) on the basis of an image at a time (t) used for detecting a moving object.

Meanwhile, when a number of moving objects is determined to be equal or relatively greater than a number of terminal objects in S532-b, it may means that a terminal object is not detected. When a terminal object is not detected on the basis of a wireless signal, re-detecting a terminal object at the corresponding time is not possible. Accordingly, in S534, the precise positioning determining apparatus may estimate coordinate values (X_sensor(j), Y_sensor(j)) of a terminal object that is lost by performing interpolation using coordinate values (X_sensor(j−1), Y_sensor(j−1)) of a terminal object determined at a previous time and coordinate values (X_sensor(j+1), Y_sensor(j+1)) of the terminal object determined at a following time.

When the number of moving objects and the number of terminal objects are identical in S532-c, the precise positioning determining apparatus may perform step of S535.

A plurality of moving objects and a plurality of terminal objects may be present, and thus it is impossible to determine which objects correspond to each other. Accordingly, determining how the plurality of moving objects and the plurality of the terminal objects correspond to each other has to be performed. For the same, in S535, the precise positioning determining apparatus may determine distance information of each object by using coordinate values (X_video, Y_video) of a moving object and coordinate values (X_sensor, Y_sensor) of a terminal object. For example, the precise positioning determining apparatus may determine distance information Distance(X_video, Y_video, i) between a moving object and a terminal object by using Formula 1 above.

In S536, the precise positioning determining apparatus may perform mapping for image positioning information and wireless positioning information by using distance information calculated in S535. For example, a difference value with coordinate values (X_sensor, Y_sensor) of a terminal object may be determined on the basis of coordinate values (X_video(i), Y_video(i)) of an i-th moving object by using the distance calculation unit 45, and the precise positioning determining apparatus may determine a terminal object having the smallest difference coordinate values. On the basis of the same, mapping for the image positioning information and the wireless positioning information may be performed.

Meanwhile, in S540, the precise positioning determining apparatus may determine an object that is finally detected on the basis of the mapped image positioning information and the wireless positioning information, and provide final positioning information of the detected object, for example, coordinate values (X_fusion, Y_fusion) of final positioning information.

By using the above precise positioning determining apparatus and method according to the present disclosure, an object included in an image can be accurately detected. Particularly, an error of detecting a player object included in a sport image or an error of ID conversion caused by confusion of the player object can be prevented. In addition, a player object that moves fast can be accurately detected without missing the same, and a relative large amount of positioning information can be detected compared to wireless positioning information detected on the basis of wireless signal. Further, a player object included in a sport image can be accurately analyzed by proving information that is spatially and temporally accurate and reliable.

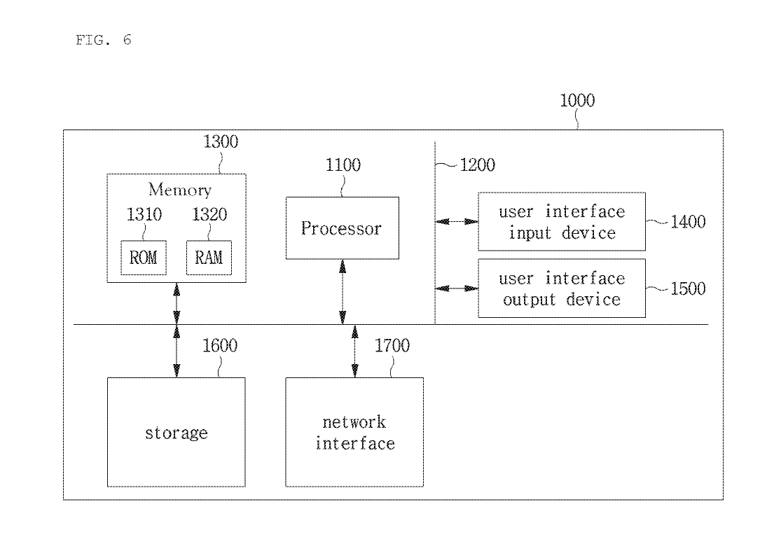

FIG. 6 is a block diagram showing an example of a computing system executing a precise positioning determining method and apparatus according to an embodiment of the present disclosure.

Referring to FIG. 6, a computing system 100 may include at least one processor 1100 connected through a bus 1200, a memory 1300, a user interface input device 1400, a user interface output device 1500, a storage 1600, and a network interface 1700.

The processor 1100 may be a central processing unit or a semiconductor device that processes commands stored in the memory 1300 and/or the storage 1600. The memory 1300 and the storage 1600 may include various volatile or nonvolatile storing media. For example, the memory 1300 may include a ROM (Read Only Memory) and a RAM (Random Access Memory).

Accordingly, the steps of the method or algorithm described in relation to the embodiments of the present disclosure may be directly implemented by a hardware module and a software module, which are operated by the processor 1100, or a combination of the modules. The software module may reside in a storing medium (that is, the memory 1300 and/or the storage 1600) such as a RAM memory, a flash memory, a ROM memory, an EPROM memory, an EEPROM memory, a register, a hard disk, a detachable disk, and a CD-ROM. The exemplary storing media are coupled to the processor 1100 and the processor 1100 can read out information from the storing media and write information on the storing media. Alternatively, the storing media may be integrated with the processor 1100. The processor and storing media may reside in an application specific integrated circuit (ASIC). The ASIC may reside in a user terminal. Alternatively, the processor and storing media may reside as individual components in a user terminal.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

What is claimed is:

1. A method of determining precise positioning, the method comprising:
determining at least one piece of image positioning information of at least one image object detected from at least one image;
determining at least one piece of wireless positioning information of at least one wireless object on the basis of signal strength of a wireless signal;
performing mapping for the at least one piece of image positioning information and the at least one piece of wireless positioning information; and
determining final positioning information on the basis of information of the at least one piece of image positioning information and the at least one piece of wireless positioning information for which mapping is performed.

2. The method of claim 1, wherein the performing of mapping for the at least one piece of image positioning information and the at least one piece of wireless positioning information includes:
calculating distance information between the at least one piece of image positioning information and the at least one piece of wireless positioning information; and
performing of mapping for the at least one piece of image positioning information and the at least one piece of wireless positioning information on the basis of the calculated distance information.

3. The method of claim 1, wherein the performing mapping for the at least one piece of image positioning information and the at least one piece of wireless positioning information includes: synchronizing the at least one piece of image positioning information and the at least one piece of wireless positioning information on the basis of detection times of the at least one piece of image positioning information and the at least one piece of wireless positioning information.

4. The method of claim 3, wherein the performing mapping for the at least one piece of image positioning information and the at least one piece of wireless positioning information further includes: setting as the same object the at least one piece of image positioning information and the at least one piece of wireless positioning information when detection times thereof are matched.

5. The method of claim 3, wherein the performing mapping for the at least one piece of image positioning information and the at least one piece of wireless positioning information further includes:
determining the at least one piece of image positioning information or the at least one piece of wireless positioning information in which detection times of the at least one piece of image positioning information and the at least one piece of wireless positioning information are not matched; and
correcting the at least one piece of image positioning information or the at least one piece of wireless positioning information by taking into account the detection times of the at least one piece of image positioning information and the at least one piece of wireless positioning information that are not matched.

6. The method of claim 1, wherein the performing mapping for the at least one piece of image positioning information and the at least one piece of wireless positioning information includes:
determining a first number of pieces of the image positioning information and a second number of pieces of the wireless positioning information; and
performing mapping for the at least one piece of image positioning information and the at least one piece of wireless positioning information by taking into account whether or not the first number and the second number are identical.

7. The method of claim 6, wherein the performing mapping for the at least one piece of image positioning information and the at least one piece of wireless positioning information includes:
re-detecting the at least one image object from the at least one image when the second number is greater than the first number;
determining at least one piece of image positioning information of the at least one re-detected image object; and
performing mapping for the at least one piece of image positioning information of the at least one re-detected image object and the at least one piece of wireless positioning information.

8. An apparatus for determining precise positioning, the apparatus comprising:
an image positioning information determining unit determining at least one piece of image positioning information of at least one image object detected from at least one image;
a wireless positioning information determining unit determining at least one piece of wireless positioning information on the basis of signal strength of a wireless signal;
a positioning information mapping unit performing mapping for the at least one piece of image positioning information and the at least one piece of wireless positioning information; and
a final positioning information determining unit determining final positioning information on the basis of information of the at least one piece of image positioning information and the at least one piece of wireless positioning information for which mapping is performed.

9. The apparatus of claim 8, wherein the positioning information mapping unit includes:
a distance information calculation unit calculating distance information between the at least one piece of image positioning information and the at least one piece of wireless positioning information; and
a mapping process unit mapping the at least one piece of image positioning information and the at least one piece of wireless positioning information on the basis of the calculated distance information.

10. The apparatus of claim 8, wherein the positioning information mapping unit further includes a synchronization unit that synchronizes the at least one piece of image positioning information and the at least one piece of wireless positioning information on the basis of detection times of the at least one piece of image positioning information and the at least one piece of wireless positioning information.

11. The apparatus of claim 10, wherein the positioning information mapping unit sets as the same object the at least one piece of image positioning information and the at least one piece of wireless positioning information when detection times thereof are matched.

12. The apparatus of claim 10, wherein the positioning information mapping unit:
determines the at least one piece of image positioning information or the at least one piece of wireless positioning information in which detection times thereof are not matched; and
corrects the at least one piece of image positioning information or the at least one piece of wireless positioning information by taking into account the detection times of the at least one piece of image positioning information and the at least one piece of wireless positioning information that are not matched.

13. The apparatus of claim 8, wherein the positioning information mapping unit:
determines a first number of pieces of the image positioning information and a second number of pieces of the wireless positioning information; and
performs mapping for the at least one piece of image positioning information and the at least one piece of wireless positioning information by taking into account whether or not the first number and the second number are identical.

14. The apparatus of claim 13, wherein the positioning information mapping unit:
re-detects the at least one image object from the at least one image when the second number is greater than the first number;
determines at least one piece of image positioning information of the at least one re-detected image object; and
performs mapping for the at least one piece of image positioning information of the at least one re-detected image object and the at least one piece of wireless positioning information.
